(19) United States
(12) Patent Application Publication
(10) Pub. No.: US 2005/0057356 A1
(43) Pub. Date: Mar. 17, 2005

(54) Warning system and method for monitoring the availability of medical aids for a patient

(76) Inventors: Thomas Ehben, Weisendorf (DE); Michael Mankopf, Mohrendorf (DE)

Correspondence Address: Alexander J. Burke;Intellectual Property Department, 5th Floor, 170 Wood Avenue South, Iselin, NJ, 08830, US

(21) Appl. No.: 10/930,120

(22) Filed: Aug. 31, 2004

(30) Foreign Application Priority Data
Sep. 1, 2003 (DE) 10340187.3

(51) Int. Cl. G08B 1/08

(52) U.S. Cl. 340/539.12

(57) ABSTRACT

The present invention relates to a warning system and a method for monitoring the availability of medical aids for a patient. The warning system comprises a first signal transmitter, which can be mounted on the aid or on a container for the aid or can be integrated in the aid or container and which has a transmission unit for transmitting first electromagnetic signals, and a second signal transmitter which can be worn by the patient and which has a warning device for outputting a warning signal which can be perceived by the patient, a reception unit for receiving the first electromagnetic signals transmitted by the transmission unit in the first signal transmitter, and a control unit which, when the first electromagnetic signals are received or when a prescribable reception strength for the first electromagnetic signals is undershot and/or when a particular item of information transmitted with the first electromagnetic signals is received, actuates the warning device to output the warning signal. The present warning system reliably draws a patient's attention to when medical aids which are important to him are no longer directly available.

### DESCRIPTION

The present invention relates to a warning system and a method for monitoring the availability of medical aids for a patient, particularly for monitoring the availability of important medicaments.

Numerous people are dependent on medical aids, such as medicaments or medical devices, on account of an illness, dysfunction or disablement. In everyday life, it is very important for these people to be able to obtain the medical aids in a short time. One example is emergency medicaments for patients who suffer from asthma or angina pectoris. If these emergency medicaments are mislaid by the patients, are lost or, when needed, are not ready to operate or have been used up, the patients in question may experience life-threatening acute states of health. Normally, the patients themselves are responsible for the availability and the regular state of the medicaments. Particularly in everyday life, however, the patients may not always have full control over the availability of their medicaments, for example on account of outside diversion. This also applies in the same way to the time at which medicaments which need to be taken at firmly prescribed intervals of time are taken. The inventors are currently not aware of any prior art which provides the patient with a reliable aid to avoiding the above problems.

The object of the present invention is therefore to specify a system and a method which automatically draw a patient's attention to when medical aids which are important to him are no longer directly available and/or need to be used.

The object is achieved by the warning system and the method in line with patent claims 1 and 15. Advantageous configurations of the warning system and of the method are the subject matter of the subclaims or can be found in the description below and in the exemplary embodiments.

The present warning system for monitoring the availability of medical aids for a patient, particularly of medicaments, comprises a first signal transmitter on the aid and a second signal transmitter on the patient. The first signal transmitter can be mounted on the medical aid or on a container for the aid or can be integrated in the aid or the container. By way of example, this first signal transmitter can thus be integrated in the packaging for a medicament as medical aid. The first signal transmitter has a transmission unit for transmitting first electromagnetic signals, and the second signal transmitter has a corresponding reception unit for receiving the first electromagnetic signals transmitted by the transmission unit in the first signal transmitter. In addition, the patient's second signal transmitter comprises a warning device for outputting a warning signal which can be perceived by the patient, and a control unit for actuating the warning device. The second, patient's signal transmitter may be worn by the patient, for example in the form of a finger ring, on a bracelet or on a necklace. It may also be integrated in practical items or items of jewelry, such as wristwatches or charms. The task of the patient's signal transmitter is to warn the patient when necessary by means of the perceptible warning signal, for example a visual alarm, an audible alarm, a vibration alarm or a combination of two or all of these types of alarms. Appropriate configurations of the warning device are known to the person skilled in the art from the prior art. The control unit in the patient's second signal transmitter is in a form such that, when the first electromagnetic signals are received or when a prescribable reception strength for the first electromagnetic signals is undershot and/or when a particular item of information transmitted with the first electromagnetic signals is received, it actuates the warning device to output the warning signal.

The use of this warning system and of the corresponding method draws the patient's attention, depending on the configuration of the system, to the fact that the medical aid which is important to him, for example an emergency medicament or a medical device which is occasionally needed urgently on a spontaneous basis, is no longer within a particular reach and/or is not in a regular, i.e. usable, state. Alternatively or in addition, the warning signal may also be used to draw the patient's attention to the fact that he needs to use the medical aid soon.

In one advantageous configuration of the present warning system and of the associated method, the aid's first signal transmitter also has one or more sensors which detect a state of the aid which is fundamental to use, for example the filling level of a medicament container or the vapor pressure in a spray bottle or pressurized bottle. Another example is sensors for emptied blister packs for medicaments. In this case, the first signal transmitter additionally has a control unit for actuating the transmission unit which, when an irregular state of the aid is identified, for example when a minimal filling level or vapor pressure is detected, actuates the transmission unit either to transmit an electromagnetic signal or a particular signal sequence or to transmit the detected state of the aid in a response signal which is regularly requested by the patient's signal transmitter.

Depending on the configuration of the warning system or of the method, the signal transmission between the patient's second signal transmitter and the aid's first signal transmitter may take place in different ways, it naturally also being possible to combine the configurations indicated below with one another.

Thus, in a first configuration, the aid's first signal transmitter can transmit an electromagnetic signal to the patient's second signal transmitter at regular intervals. If it does not reach the patient's signal transmitter, for example because the aid is too far away from the patient, then the patient's second signal transmitter triggers the warning signal, since the reception strength has fallen below a prescribable threshold value. In this configuration, the patient's attention is thus easily drawn to when he unconsciously moves too far away from the medical aid which is important to him, such as an emergency medicament.

In a second configuration, the patient's second signal transmitter transmits an interrogation signal to the aid's first signal transmitter at regular intervals. The first signal transmitter returns a response signal when it receives this interrogation signal. If this response signal does not reach the patient's second signal transmitter, then a warning signal is produced in the same way as in the first configuration. In a development of this second configuration, in which the state of the medical aid is detected by means of sensors, the response signal may also contain information about this state of the aid. In this case, the information is identified by the control unit in the patient's second signal transmitter, and a warning signal is likewise triggered if the aid is not in a regular state. This configuration thus provides the patient with the further advantage that he is informed about an irregular state of his aid in good time, which means that he can take appropriate measures.

In a third configuration, the aid's first signal transmitter transmits a signal to the patient's second signal transmitter as soon as the sensors detect an irregular state of the aid. The control unit in the patient's second signal transmitter triggers a warning signal on the basis of this received signal. In a development or alternative configuration, the aid's signal transmitter also transmits a signal to the patient's signal transmitter when a firmly prescribed interval for taking or using the aid is not observed by the patient. The observing of this interval can be checked using the sensors, which can detect the use of the aid using an appropriate state change. In this way, the patient is reliably reminded if he does not observe the prescribed interval of time, which is normally a necessity.

In a further configuration of the present warning system and of the associated method, the patient's attention may also be drawn by means of a warning signal to the fact that the end of the life of a medicament, as a medical aid, has been reached or is immediately imminent as soon as this happens. For example, either the patient's signal transmitter or the aid's signal transmitter may contain a time comparison device which compares a programmed comparison time, for example the use-by date, linked to the aid with the respective present time. This naturally also requires an appropriate internal clock, which may also be a radio clock. The comparison time can be set, by way of example, by the patient when breaking open a new pack unit of a medicament, or by the distributor of the medicament or can be firmly programmed into the aid's signal transmitter when the medicament is actually manufactured, if this signal transmitter is mounted on the medicament's pack or in its pack when the medicament is actually manufactured.

The two signal transmitters can be supplied with power by means of batteries. The fact that the transmission of signals is not continual means that the power consumption is low. It goes without saying that solutions are also possible in which, by way of example, the medicament's signal transmitter obtains its power from the patient's signal transmitter or from the ambient noise by means of respective electromagnetic waves. Such techniques are known from the field of wireless information transmission and also from RF-ID (Radio-Frequency Identification) tag technology.

In one development of the present warning system and of the associated method, in addition to alerting the patient using the patient's signal transmitter, it is also possible to transmit a warning message to other people, for example to a carer or a treating physician. To this end, the patient's signal transmitter or the aid's signal transmitter has an interface to an external reception unit which can be used to transmit the warning message to the appropriate other person when a warning signal arises. Thus, by way of example, a connection may be set up to a mobile radio network in order to activate a mobile telephone belonging to the other person, for example in order to draw his attention to the medical aid's fault status. The use of other wireless transmission techniques as a result of the integrated interface being in an appropriate form is naturally also possible, such as a direct wireless short-haul connection directly to a mobile telephone, for example using Bluetooth. Such communication may also be used for automatically requesting a new prescription or a new pack of a medicament if said medicament is no longer in a regular state or has been used up. In addition, when using such an integrated interface, it is also possible to inform a treating physician or other care people if the patient is not taking his medication on a regular basis. Finally, it is also possible to alert care people using the Internet, in which case the patient's signal transmitter then transmits a corresponding item of information to a public mobile radio network directly or using, a mobile telephone which is close by.

The present warning system and the associated method are explained again below using exemplary embodiments in conjunction with the drawings, in which:

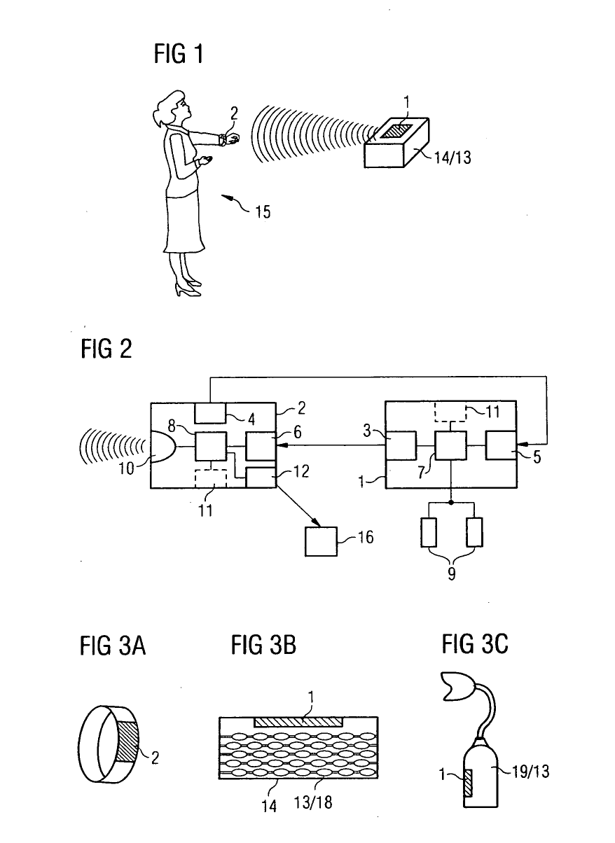

FIG. 1 shows an illustration of the use of the present warning system;

FIG. 2 shows a schematic illustration of components of the present warning system in one possible configuration; and

FIG. 3 shows examples of integration or mounting of the signal transmitters in different articles.

When the present warning system is being used, the patient 15 wears the second signal transmitter 2 constantly on his body, for example integrated in a wristwatch, as illustrated in FIG. 1. In this example, the patient 15 is reliant on an important medicament which is packaged in a container 14. The aid's signal transmitter 1 is also mounted in this container 14 and transmits electromagnetic signals at regular intervals. When the medicament is in the relatively close surroundings of the patient 15, the patient's signal transmitter 2 receives the electromagnetic signals at sufficient reception strength. If the patient 15 forgets his medicament, for example in his apartment, and leaves the apartment, then the patient's signal transmitter 2 outputs a warning signal when a particular range is exceeded, since the received signal has then dropped below a threshold value. The patient 15 can then return and take the medicament with him. This makes it possible to prevent the patient from inadvertently getting into a situation in which he cannot access his medicament if required.

FIG. 2 shows a schematic illustration of individual components of the present warning system in one possible configuration. The left-hand side of the figure shows the patient's signal transmitter 2, which has a reception device 6 and a warning device 10, which are both connected to a control unit 8. The aid's signal transmitter 1, shown on the right-hand side, comprises a transmission device 3 for transmitting electromagnetic signals to the reception device 6 in the patient's signal transmitter 2, as indicated by the arrow. These components are sufficient to ensure that the warning system works in the manner explained in connection with FIG. 1. In this context, the control unit 8 in the patient's signal transmitter 2 checks the reception strength of the received signal. If a prescribable threshold value is undershot, the warning device 10 is actuated to output a warning signal.

In further forms of the present warning system, the aid's signal transmitter 1 also comprises a control unit 7, which actuates the transmission unit 3 to output an electromagnetic signal when required. By way of example, this control unit 7 may be connected to one or more sensors 9 which detect the state of the aid. If an irregular state is detected, the control unit 7 can then actuate the transmission unit 3 to output one or more electromagnetic signals, and when these are received by the reception unit 6 in the patient's signal transmitter 2, the control unit 8 likewise prompts a warning signal.

In addition, the patient's signal transmitter 2 may have a transmission unit 4 and the aid's signal transmitter 1 may have a reception unit 5. In such a configuration, the patient's signal transmitter 2 can transmit electromagnetic signals at regular intervals in order to interrogate the aid's signal transmitter 1. When such interrogation signals are received by the reception unit 5, the control unit 7 in the aid's signal transmitter 1 prompts the transmission unit 3 to output a corresponding response signal. If the patient's signal transmitter 2 does not receive any such response signal to an interrogation signal, a warning signal is triggered. In addition, the control unit 7 may also incorporate information about the state of the aid detected by means of the sensors 9 into the response signal. In this case, the information is evaluated by the control unit 8 in the patient's signal transmitter 2 and a warning signal is likewise triggered if the aid is in an irregular state.

FIG. 2 also indicates, in dashes, the time comparison device 11 explained in the description above, this device being able to be arranged either in the patient's signal transmitter 2 or in the aid's signal transmitter 1. This time comparison device 11 is used for producing a warning signal when the use-by date for a medicament, as the medical aid, is reached.

FIG. 2 also shows the interface 12 for a wireless connection to an external reception station 16 which can be used to transmit a warning message, for example to the mobile telephone of a care person. In the case of a medicament as the medical aid, the check on the stock of medicaments using the sensor or sensors 9 in conjunction with the output of a warning message via the interface 12 also allows automatic requesting of a follow-up prescription or the reordering of a medication, which avoids any interruption in the medication and allows administrative costs to be saved.

The patient's signal transmitter 2 is preferably miniaturized such that it can be worn on the body as a ring 17 or other piece of jewelry, as indicated in FIG. 3a. The aid's signal transmitter 1 can be integrated, by way of example, in a container 14 for medicaments or can be mounted in this container 14 or can be integrated directly in the medical aid 13 or mounted thereon. Both options are illustrated in FIGS. 3b and 3c, FIG. 3b illustrating a medicament pack as the container 14 containing blister packs 18, and FIG. 3c illustrating an inhaler 19 with a gas bottle on whose inner wall the aid's signal transmitter 1 is mounted. In the latter case, this signal transmitter may have a pressure or filling level sensor for detecting the state of the gas bottle filling.

In this context, the aid's signal transmitter 1 may be produced using polymer electronic circuitry, for example, and is preferably integrated directly in the medicament pack. The former aspect is particularly beneficial for medicaments' disposable packaging, since such circuits can be produced inexpensively and in a space-saving manner.

1. A warning system for monitoring the availability of medical aids for a patient, particularly of medicaments, which comprises a first signal transmitter, which can be mounted on the aid or on a container for the aid or can be integrated in the aid or container and which has a transmission unit for transmitting first electromagnetic signals, and a second signal transmitter which can be worn by the patient and which has a warning device for outputting a warning signal which can be perceived by the patient, a reception unit for receiving the first electromagnetic signals transmitted by the transmission unit in the first signal transmitter, and a control unit which, when the first electromagnetic signals are received or when a prescribable reception strength for the first electromagnetic signals is undershot and/or when a particular item of information transmitted with the first electromagnetic signals is received, actuates the warning device to output the warning signal.

2. The warning system as claimed in claim 1, characterized in that the first signal transmitter has a control unit for actuating the transmission unit.

3. The warning system as claimed in claim 2, characterized in that the first signal transmitter comprises one or more sensors which are connected to the control unit and detect a state of the aid which is fundamental to the usability of the aid.

4. The warning system as claimed in claim 1, characterized in that the transmission unit in the first signal transmitter is designed to transmit the first electromagnetic signals at regular intervals of time.

5. The warning system as claimed in claim 2 characterized in that the second signal transmitter has a transmission unit for transmitting second electromagnetic signals, and the first signal transmitter has a reception unit, connected to the control unit, for receiving the second electromagnetic signals transmitted by the transmission unit in the second signal transmitter, the control unit being designed such that, when the second electromagnetic signals are received, it actuates the transmission device to transmit a response signal.

6. The warning system as claimed in claim 5, characterized in that the transmission unit in the second signal transmitter is designed to transmit the second electromagnetic signals at regular intervals of time.

7. The warning system as claimed in claim 5 characterized in that the control unit in the first signal transmitter is designed such that it transmits an item of information about the state of the aid detected by the sensors with the response signal.

8. The warning system as claimed in claim 7, characterized in that the control unit in the second signal transmitter actuates the warning device upon receiving a response signal which contains an item of information about an irregular or incorrect state of the aid.

9. The warning system as claimed in claim 3, characterized in that the control unit in the first signal transmitter is designed such that, upon detection of an irregular or incorrect state of the aid, it actuates the transmission unit to transmit the first electromagnetic signals or an item of information transmitted with the first electromagnetic signals about the irregular or incorrect state of the aid.

10. The warning system as claimed in claim 1 characterized in that the control unit in the first or second signal transmitter comprises a time comparison device which prompts the output of a warning signal during and/or at a prescribable interval of time before a time linked to the aid is reached.

11. The warning system as claimed in claim 1 characterized in that the second signal transmitter is miniaturized such that it can be worn by the patient in the form of a finger ring or other comparably small piece of jewelry.

12. The warning system as claimed in claim 1 characterized in that the first signal transmitter is miniaturized such that it can be accommodated together with medicaments in a medicament pack.

13. The warning system as claimed in claim 1 characterized in that the second signal transmitter has a wireless interface to an external reception device which can be used to transmit a warning message to other people.

14. The warning system as claimed in claim 1 characterized in that the first signal transmitter is produced using polymer electronic circuitry.

15. A method for monitoring the availability of medical aids for a patient, particularly of medicaments, in which a first signal transmitter is mounted on the aid or on a container for the aid or is integrated in the aid or container, said first signal transmitter having a transmission unit for transmitting first electromagnetic signals, and in which the patient carries a second signal transmitter with him which has a reception unit for receiving the electromagnetic signals transmitted by the transmission unit in the first signal transmitter and, when the first electromagnetic signals are received or when a prescribable reception strength for the first electromagnetic signals is undershot and/or when a particular item of information transmitted with the first electromagnetic signals is received, outputs a warning signal which can be perceived by the patient.

16. The method as claimed in claim 15, characterized in that the first electromagnetic signals are transmitted at regular intervals of time.

17. The method as claimed in claim 15, characterized in that the second signal transmitter has a transmission unit for transmitting second electromagnetic signals, and the first signal transmitter has a reception unit for receiving the second electromagnetic signals, the first signal transmitter transmitting a response signal when second electromagnetic signals are received.

18. The method as claimed in claim 17, characterized in that the second electromagnetic signals are transmitted at regular intervals of time.

19. The method as claimed in claim 15 characterized in that a state of the aid which is fundamental to the usability of the aid is detected by means of one or more sensors in the first signal transmitter.

20. The method as claimed in claim 19 characterized in that an item of information about the state of the aid is incorporated into the response signal.

21. The method as claimed in claim 20, characterized in that the second signal transmitter outputs a warning signal when a response signal signaling an irregular or incorrect state of the aid is received.

22. The method as claimed in claim 19, characterized in that, when an irregular or incorrect state of the aid is detected, the first signal transmitter transmits first electromagnetic signals or transmits an item of information about the irregular or incorrect state of the aid with the first electromagnetic signals.

23. The method as claimed in claim 15 characterized in that the first or second signal transmitter regularly compares a present time with a time linked to the aid, and the second signal transmitter outputs a warning signal during and/or in a prescribable period before the time is reached.

24. The method as claimed in claim 15 characterized in that the first signal transmitter is accommodated together with medicaments in a medicament pack.

25. The method as claimed in one of claims 15 characterized in that the second signal transmitter sets up a connection via a wireless interface to an external reception device when a warning signal occurs and uses the external reception device to transmit a warning message to one or more other people.
